(19) United States
(12) Patent Application Publication
(10) Pub. No.: US 2026/0268667 A1
(43) Pub. Date: Sep. 10, 2026

(54) EVENT-BASED IMAGE PROCESSING

(71) Applicant: CUVOS PTY LTD, Sydney, New South Wales (AU)

(72) Inventors: Tara Hamilton, Sydney, New South Wales (AU); Benjamin Essam, Sydney, New South Wales (AU); Andrew Nicholson, Sydney, New South Wales (AU)

(73) Assignee: CUVOS PTY LTD, Sydney, New South Wales (AU)

(21) Appl. No.: 19/166,455

(22) PCT Filed: Mar. 19, 2024
(86) PCT No.: PCT/AU2024/050243

§ 371 Date: Sep. 17, 2025

(30) Foreign Application Priority Data
Mar. 20, 2023 (AU) 2023900771

(51) Int. Cl. G06V 20/40; G06T 5/20; G06T 7/13; H04N 25/47

(52) U.S. Cl. CPC G06V 20/44; G06T 5/20; G06T 7/13; H04N 25/47

(57) ABSTRACT

Disclosed is an event-based image processing method. The method includes obtaining a time series of input signal data characterising information from an input source; applying a first stage of processing, wherein the first stage of processing comprises applying a compressive non-linearity to the input signal data; and applying a second stage of processing to an output from the first stage of processing. The second stage of processing comprises temporal and/or spatial processing in a feedback loop, to apply a high- or band-pass temporal filter and/or a high- or band-pass spatial filter to the output from the first stage of processing, to thereby suppress recurring changes, and improving an event to recurring change ratio in the output from the first stage of processing.

### TECHNICAL FIELD

This disclosure relates to a method and device for event-based image processing.

### BACKGROUND ART

Event-based image sensors (EBS), also known as Dynamic Vision Sensors (DVS), have become popular in the last few years. Their operation is based on the biology of animal eyes and follows a neuromorphic approach to technology development. EBS are favoured in situations where lighting conditions are challenging, data-throughput is important, and power is constrained.

The earliest event-based sensor (EBS) was described by T. Delbuck in the article “A 128×128 120 dB 15 μs Latency Asynchronous Temporal Contrast Vision Sensor,” IEEE Journal of Solid-State Circuits, vol. 43, no. 2, pp. 566-576, February 2008, doi: 10.1109/JSSC.2007.914337. That work included a simplified circuit for the EBS which is reproduced here in FIG. 1, and the principle of operation which is reproduced here in FIG. 2.

The circuit shown in FIG. 1 stores the change in the voltage at each time step, where the stored voltage change corresponds to the logarithm of the change in photodiode current across the capacitor C1. This value of the photodiode current change is amplified by C1/C2 to generate the voltage change value, V_{diff}. V_{diff} is used to determine whether the change in the logarithm of the photodiode current is great enough to generate an “event”. “On” events are generated when the value of V_{diff} has positively increased by a minimum amount, and “Off” events are generated where there has been a sufficiently large negative change. The required magnitude of the changes, the “threshold”, is globally set for both the positive change and the negative change.

Taking the logarithm of the photodiode current results in small changes in the current being amplified more than large changes in the current. This compressive nonlinearity is similar to that seen in biological sensory organs. The difference with the EBS, however, is that 1) the EBS only reports whether the change is positive, negative, or if no change has occurred, rather than the magnitude of the change; and 2) the logarithmic compressive nonlinearity is set. FIG. 3 illustrate this nonlinearity. Thus, there is no way of exploring different types of nonlinearity. Additionally, the parameters of the logarithmic response are set.

In practice, the uptake of the EBS technology has been slow due to a number of drawbacks in their real-world performance and operational constraints.

Currently, bespoke EBS solutions are available on the market, such as those produced by Prophesee (https://www.prophesee.ai/) and IniVation (https://inivation.com/). However, the currently available EBS solutions still require optimal lighting conditions to maintain stated performance specifications. In low lighting situations where photons are scarce, or in complex lighting conditions where the amount of photons may not be stable, the reliability of the performance suffers. Also, processing is required in order to interpret the event data provided by the EBS. Event data is asynchronous, which means that as pixels generate events they are time-stamped and put onto an event-bus. In low or sub-optimal lighting conditions where noise can easily overwhelm “event” data, to be able to generate events, the processing will need to be performed by very fast hardware, or the threshold for event detection will need to be set to be very high. When the threshold is set high, this reduces the benefits of the high dynamic range of the EBS. On the other hand, using fast post-processing hardware requires high-powered computational solutions such as GPUs or FPGAs.

There are some research papers on implementations of EBS using software or digital hardware such as FPGAs. Most of these papers have focused on emulating the analogue circuit performance of an EBS rather than the biological functionality of Type M retinal ganglion cells. In essence, the models try to emulate what is already itself an abstracted model of the biological function. The software simulations or digital emulators are used in place of actual EBS solution, and do not improve on the existing EBS.

It is to be understood that, if any prior art is referred to herein, such reference does not constitute an admission that the prior art forms a part of the common general knowledge in the art, in Australia or any other country.

### SUMMARY

Disclosed herein are embodiments of alternative solutions to the presently available EBS system.

In a first aspect, there is disclosed an image processing method. The method comprises: obtaining a time series of input signal data characterising information from an input source; applying a first stage of processing, wherein the first stage of processing comprises applying a compressive non-linearity (or alternative nonlinear signal processing that increases the information e.g. delentropy of the input frame) to the input signal data; and applying a second stage of processing to an output from the first stage of processing. The second stage of processing comprises spatial and/or temporal processing in a feedback loop, to apply a high- or band-pass spatial and/or temporal filter to the output from the first stage of processing, to thereby suppress recurring (and slow) changes, and improving an event to recurring change ratio in the output from the first stage of processing. In some forms, the method comprises detecting events in an output of the second stage of processing. An event may be defined as a change in pixel intensity over time that meets a particular slew-rate threshold.

In some forms, detecting events includes applying at least one threshold to pixel values in the output of the second stage of processing.

In some forms, the applied threshold includes multiple thresholds, each applied to a respective pixel or a respective set of pixels.

In some forms, detecting events includes setting an event speed for a detected event.

In some forms, detecting events includes setting two different event speeds, each for a respective one of two different detected events.

In some forms, the event speed is set by setting a counter, being a number of clock cycles during which the detected event is considered to persist.

In some forms, the temporal high- or band-pass filter is nth order filter, wherein n corresponds to a number of time steps incorporated in the temporal processing.

In some forms, n equals 1.

In some forms, n is greater than 1.

In some forms, the temporal high- or band-pass filter is in infinite impulse response filter.

In some forms, a gain for the temporal high- or band-pass filter is variable based on at least one or more of: a characteristic of the input source; a characteristic of an environment about which the input source is acquiring the input data.

In some forms, the second stage of processing further comprises spatial processing configured to detect edges. Examples of edge detection algorithms include, e.g., Sobel filtering, Canny Edge Detection, etc.

In some forms, the spatial processing is configured to occur before or after the temporal processing.

In some forms, the spatial processing applies a spatial high-pass filter implemented using convolution.

In some forms, the first stage of processing comprises a temporal feedback loop, in which current and previous samples from the input signal data and at least a previous sample of the output from the first stage of processing are used to obtain a current sample of the output from the first stage of processing.

In some forms, applying said compressive non-linearity to the input data comprises applying a gain to the input signal data, the gain being variable on the basis of a magnitude of the input signal data.

In some forms, the first stage of processing comprises a plurality of processing modules, each configured for favourably processing input data of a different characteristic.

In some forms, the processing modules comprises a first processing module for favourably processing input data of lower magnitudes and a second processing module for favourably processing input data of higher magnitudes.

In some forms, each processing module of the first processing stage comprises a divisive low-pass filter.

In some forms, the input source comprises an image sensor, and the times series of input data is a series of frames, each frame comprising a plurality of pixels, where the first and second stages of processing are applied on a per-pixel basis.

In some forms, the image sensor is an electro-optics sensor, camera, or an infrared image sensor, or another sensor which comprises one or more pixels.

In a second aspect, herein disclosed is a signal processing device comprising a plurality of processing modules. The modules includes: a first processing module configured to receive and process a time series of input signal from an input source, wherein the first processing module is configured to apply a compressive non-linearity to the received input signal. The modules also include a second processing module configured to receive output from the first processing module, wherein the second processing module is configured to implement spatial and/or temporal processing in a feedback loop, to apply a high- or band-pass spatial and/or temporal filter to the output from the first stage of processing, to thereby suppress recurring changes, and improving an event to recurring change ratio in the output from the first stage of processing.

In some forms, the device includes an event detection module configured to implement event detection to an output from the second processing module.

In some forms, the second processing module is further configured to apply a spatial filtering process to detect edges in the output of the first processing module.

In some forms, the first processing module or the second processing module, or both, is implemented in hardware.

In some forms, input signal comprises signal data for a set of pixels, wherein the processing modules process the input signal pixel by pixel.

### BRIEF DESCRIPTION OF THE DRAWINGS

Embodiments will now be described by way of example only, with reference to the accompanying drawings in which

FIG. 1 is schematic for a prior art circuit implementing an event-based sensor;

FIG. 2 is a schematic illustrating a principle of operation for the event-based sensor circuit shown in FIG. 1;

FIG. 3 is a schematic drawing illustrating a logarithmic compressive non-linearity;

FIG. 4 is a schematic illustration of an event-based detection system in accordance with an embodiment of the present invention;

FIG. 5 is a schematic illustration of an operation of a sliding kernel;

FIG. 6-1 depicts a set of sliding kernels configured to detect vertical and horizontal edges;

FIG. 6-2 depicts another set of sliding kernels configured to detect vertical and horizontal edges in a set of pixels;

FIG. 7(a) schematically depicts the processing in a first processing stage of an event-based detection system in accordance with an embodiment of the present invention;

FIG. 7(b) schematically depicts the processing in a first processing stage of an event-based detection system in accordance with an embodiment of the present invention;

FIG. 8-1 is a “pre-event” frame-based output showing a moving hand;

FIG. 8-2 is a “pre-event” frame-based output showing a moving camera;

FIG. 8-3 is a “pre-event” frame-based output where there is no movement;

FIG. 9 is a conceptual depiction of pixel values provided to a pipeline structure which are used to generate a filtered value for a local pixel;

FIG. 10 is an example of a rendered image of an events output obtained by processing image data capturing a drone flying.

### DETAILED DESCRIPTION

In the following detailed description, reference is made to accompanying drawings which form a part of the detailed description. The illustrative embodiments described in the detailed description, depicted in the drawings, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Herein disclosed are embodiments of an event-based sensing system. Aspects of the system including the algorithm, hardware implementation, and software extensions are discussed. As will be described, the event-based sensing system described herein is configured to apply novel processing to detect “motion events”, or “events” which indicate motion. Advantageously, the system can be configured to detect “events” on the basis of image data at the pixel-level, rather than requiring image data from a group of pixels. An event may also be defined as a change in pixel intensity over time that meets a particular slew-rate threshold.

An advantage of the system is that it can work with input data from commercial-off-the-shelf (COTS) image sensor technology, and applies digital signal processing (DSP) which enhances, finds edges and motion, and then produces “events”. Embodiments of the described system may incorporate an EBS-compatible address-event representation (AER) output, and together with the signal processing is implemented on field-programmable gate arrays (FPGAs) or application-specific integrated circuits (ASICs). AER is the generally used output protocol for the EBS. The AER protocol addresses the pixel where the event occurred in x, y coordinates and the time of the event. It relates directly to the hardware but is essentially a file protocol that can be used by EBS algorithms to process the data. The disclosed solution means that any image sensor can be converted to a high-performance EBS camera. With low-latency and including image enhancements that result in comparable or better performance than a bespoke EBS in complex and difficult light conditions, the described system provides an easy to integrate and use alternative to the EBS solutions currently available.

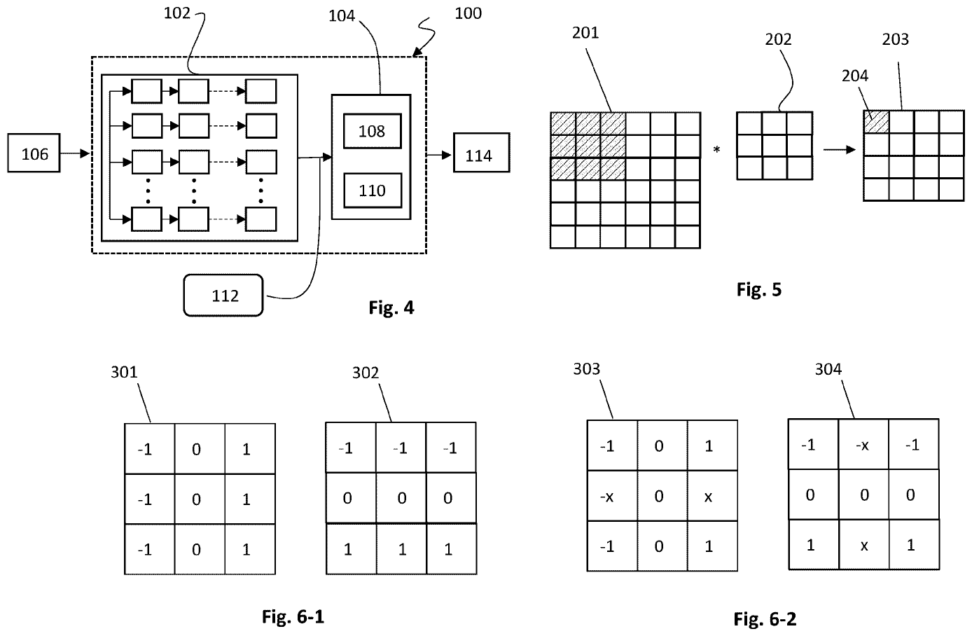

Embodiments of the event-based sensing system 100 disclosed herein comprise a first processing stage 102 and a second processing stage 104, as conceptually depicted in FIG. 4. Input to the first stage is provided by a sensor 106 which could be external to the system 100 as depicted, or built-in with the system. The first stage 102 of the system 100 implements a parametric compressive nonlinearity which increases gain for low input signals and saturates gain for high input signals, thus extending the dynamic range for each pixel output. The second stage 104 of the system is configured to find motion and edges in the images.

In some embodiments, the pixel outputs from the first stage 102 may also be tapped to provide an enhanced image 112, which compared with the original input from the sensor 106 has a better dynamic range.

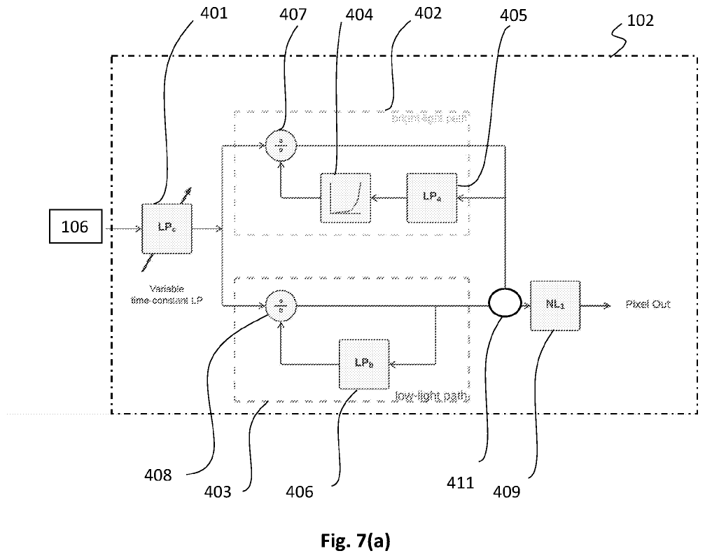

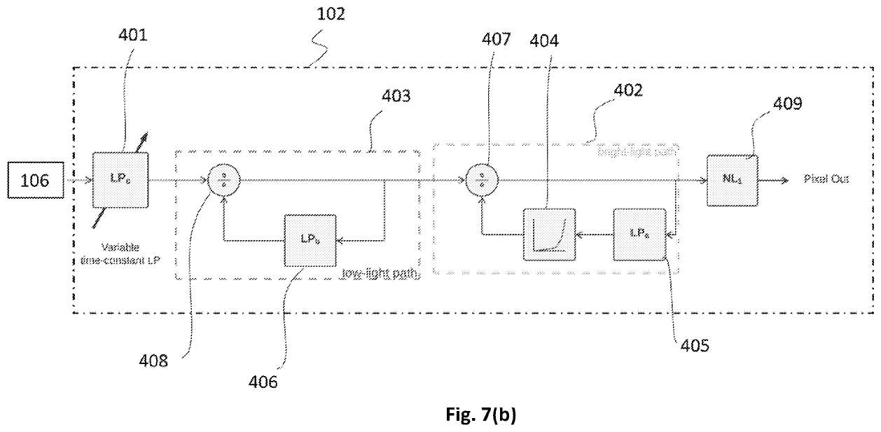

The system's first stage requires the use of memory to track the changes in the pixels, thus providing feedback for the pixel enhancement. A purpose of this stage is to enhance the dynamic range from what is available from the image sensor, as will be explained. Changes in the local pixel or global changes, or both, may be tracked. A “local” pixel refers to the individual pixel which is being processed. “Global” pixels refer to the pixels across the whole frame, or pixels in a particular region. Examples of the functions used in the first stage 102 are provided later with reference to FIG. 7.

As depicted in FIG. 4, the first stage 102 may be implemented using an N-pipeline approach. In the N-pipeline approach as applied to a time series of image data, pixel data from different portions of the frame are processed by respective pipelines. The pixels from the image are provided to each pipeline in the first stage 102 in a per-pixel manner, allowing for the tracking of changes which is occurring at a local pixel level. The pipelines may further be configured so that different subsets of pixels will provide input for a respective pipeline, allowing for the tracking of changes “globally”. The N-pipeline approach is discussed in more detail in the Applicant's Australian provisional patent application no. 2022902462, the contents of which are incorporated herein. The processing at each pipeline involves temporal processing, in that the pixel data from frames acquired at different sample times (e.g., the current frame and the previous frame) are used as input for the processing. Thus, the processing accesses memory to access data from the previous time steps. This improves the dynamic range of the system, allowing it to be able to handle image frames acquired in a wider range of lighting conditions.

The second stage 104 of the event-based sensing system applies processing to the output from the first stage 102, to find edge and motion in the image. Edge and motion detection may be done via temporal or spatial processing, or both. In one embodiment, the second stage 102 does this by applying a high- or band-pass temporal filter 108, and a spatial high-pass filter 110. The spatial high-pass filter 110 may be applied after the high pass temporal filter 108. Both filters 108, 110 are looking for edges in the data (in the pixels and in the resulting image). Therefore, the order in which they are applied may be reversed without affecting the result. Also, as both filters 108, 110 are functioning to look for edges, either or both (i.e., spatial and/or temporal filters) may be used, though preferably at least the temporal filter 108 will be included.

In some embodiments the temporal filtering 108 is applied on a per-pixel basis. In some embodiments, the temporal filter 108 is an infinite impulse response (IIR) one-tap (i.e., first order) filter. Equation (1) provides an example definition of a first order high-pass filter. In Equation (1), n is each discrete time-step, a is a gain term, x is the pixel value which is output from the first stage, and y is the output from the high pass temporal filter.

### Equation (1)

$$y [ n ] = \frac{1 + α}{2} ( x [ n ] - x [ n - 1 ] ) + α y [ n - 1 ]$$

The temporal filter 108 applied in the second stage 104 may be generalised to include one more “taps”, i.e., it can be a first order filter or it can have a higher order. The generalised equation, Equation (2), is provided below.

### Equation (2)

$$y [ n ] = \frac{1 + α}{2} ( x [ n ] - {\sum }_{i} {β}_{i} x [ n - i ] ) + α {\sum }_{i} y [ n - i ]$$

In Equation (2), n is each discrete time-step, a is a gain term, x is the pixel value which is output from stage 1, and y is the output at stage 2, and Bi is a constant that is selected for filter stability.

The temporal filter 108, being parameterizable, can be tuned to suit the application for which event-based detection is being done. The parameter a may be optimised to suit the image sensor which is used, or to suit the visual conditions or the particular target of interest. For example, the parameter a may be adjusted based on the speed of the edge that the filter is configured to capture, by adjusting the cut-off frequency on the basis of the speed of the edge. Additionally or alternatively, the filter 108 can be more tuned to particular frequencies by increasing the order of the filter i.e. increasing the steepness of the frequency cut-off. More generally, the tuning which can be applied to the filtering in this stage 104 is mainly related to the dynamic performance of the system, that is, how well the system performs in responding to the dynamics of the objects that it is capturing.

The utilisation of memory involving a plurality of time steps from the temporal filter output helps the temporal processing to account for recurring changes or change patterns. This may further be enhanced by the combination of both the utilisation of time steps and the configurable parameters for the feedback from time steps. In this way, the filter can be configured to adapt to particular characteristics of the environment being monitored by the event-based detection system. This may help to suppress known or expected movement patterns, and help to better identify the information more likely to correspond to a true event as opposed to background patterns or noise, e.g., the detection of a boat or ship in a waterway, where detection is under reduced influence from expected, background or uninteresting changes such as motions caused by waves.

The number of taps, i.e., the order of the filter, may be adjusted to tune the temporal precision. The number of taps, i.e., the order of the filter, is chosen to improve temporal precision (i.e., more frequency selective) and can assist with sub-pixel targeting. Higher order IIRs can also help reduce noise. By increasing the number of “taps” in the filter at stage 2, this is increasing the order of the filter which makes the filter more selective and thus sensitive to changes in the frequency response band of the filter. However, increasing the number of taps in a digital filter requires more memory. Therefore, there is a trade-off between precision and resource usage.

Here, “sub-pixel” targeting means that it is possible to detect a moving object whose image as captured in an image frame is smaller than a pixel. Such an object would be small enough, or far enough, or both, such that it appears smaller than a pixel in the image. As the dynamic range for the image has been enhanced by the nonlinearity in the first stage 102, it is easier during the second stage 104 for the intensity change caused by such a “sub-pixel” moving object to be differentiable from noise. The “event’ would be detected in the pixel in which the object is located.

When such a “sub-pixel” object transitions across a pixel boundary between two pixels, the changes in pixel intensities in these two pixels will be inversely proportional to one another. This is because the movement between pixels, and hence that inverse relationship between the intensity changes in the two pixels, will continue for longer periods of time and be captured across more frames. I.e. something far away which is moving across the scene which takes up a smaller number of pixels will move across the image more slowly compared with something which takes up more pixels in the image. Increasing the order of the temporal filter (i.e. the number of taps) can allow the algorithm to extract slower and slower moving objects, if the frequency cut-off is reduced. Alternatively, if only fast objects are of interest, then the frequency cut-off can be increased.

Theoretically, there is no limit to the number of taps for the chosen filter, i.e. the order of the filter. However, in practice, the number of taps may be limited by practical constraints such as the attendant increase in memory requirements. Furthermore, as the number of “taps” increases, this may not translate to significant improvement in filter performance. Thus the optimal number of taps may change in the future on the basis of advances in computing memory and the associated decrease in cost, and the characteristic of the image captured.

A distinction between the processing applied by the currently disclosed system and the conventional methods is the use of temporal filtering at the pixel level to determine edge motion, i.e., movement of edges. This filtering may be high-pass or band-pass. A common technique to approximate an EBS is using frame subtraction, e.g. according to Equation (3), which does not utilise the output y from the previous sample point. This can be interpreted as a 1st-order one-tap high-pass Finite Impulse Response (FIR) filter, which as shown in the below does not involve temporal processing utilising the filter output.

### Equation (3)

$$y [ n ] = x [ n ] - x [ n - 1 ]$$

The process which is employed in the herein described system is different. The temporal filter used in the present system removes noise by correlating the movement between pixels. For example, if pixel A changes, it is possible to determine whether the change was due to noise, by checking if what was at pixel A has moved to one of its neighbouring pixels. If none of pixel A's neighbours has a change then the change in pixel A is likely to noise and should be filtered out. In the disclosed implementation, because the temporal filter at stage 2 incorporates memory, it allows a feedback and reduces the effects of noise significantly. In addition, the use of temporal filtering (as opposed to simply subtracting frames from different sample times) is advantageous in that the filter can be parameterized with frequency cut-off and the number of taps, as mentioned previously. The output from the temporal filter 108 at stage 2 provides a frame-based pixel output that shows movement.

The frame-based pixel output from stage 2 can be considered a “pre-event” output, which is processed to generate the events output. The event generation processing is represented by block 114. Events are generated by comparing the change in the pixel value with the previous time-step, and thresholding the change with a pre-defined threshold to determine whether the output is an “ON” or “OFF”. The ON and OFF events can be coloured in an event visualizer so that the motion of objects and their direction is visible. The ON and OFF events also help with detection and tracking algorithms with determining the direction and speed of motion. Optionally, each pixel can have a respective programmable filter, rather than applying a global threshold as is the case in currently available bespoke EBS solutions. Additionally, the speed of the events can be programmed with a counter, which may be specified for each pixel. This means that for slow moving objects, the event can persist or for fast moving objects the event can move on the next clock cycle by resetting the counter to 0. This level of temporal programmability is not provided by existing EBS systems.

Referring again to FIG. 4, the spatial high-pass filter 110 which is applied in the second stage 104 is intended to detect the edges in the image data using spatial processing. By combining the temporal filter and the spatial filter, the second stage 104 of the system 100 is detection motion only in the “edges” in an image.

In image processing, an edge is a boundary between light and dark pixels or pixel regions. In its simplest form, an edge detection algorithm compares all the adjacent pixels in an image, and determines whether or not a boundary between two pixels exists. A more complicated algorithm may use the derivative of pixel intensity to determine the strength and direction of the edges. By detecting motion in only edges, it is possible to reduce some of the artifacts that may appear on objects that are in uneven lighting, like most natural scenes. The edge detection algorithm can be chosen by the skilled person. Non-limiting examples include Sobel filtering and Canny Edge Detection.

In some embodiments, the spatial high-pass filter 110 is implemented using a convolution operation. An example is a “sliding frames” approach where the input image is convoluted with a kernel which “slides” over the input image. In the “sliding frames” approach, by looking at the pixels around a point of interest, edges at the point of interest can be found by looking for differences in the data between opposite sides of the point of interest. For example, if the left is dark and the right is bright or vice versa, there is a vertical edge at this point. Repeating this for the entire image and it is possible to create an image containing only edges. Mathematically, this is described by convolution, which allows for a convenient way to generate these images. The convolution kernel which is used to “slide” across the image will be configured to detect the required transition in pixel intensity in order for the edges to be identified. FIG. 5 conceptually illustrates this approach. A sliding kernel 202 of size 3×3 is applied to the input image 201 of size 6×6, and a result image 203 of size 4×4 is obtained, the value of each pixel in the result image 203 being the result of a convolution between a subset of pixels of the same dimensions as the kernel, and the kernel.

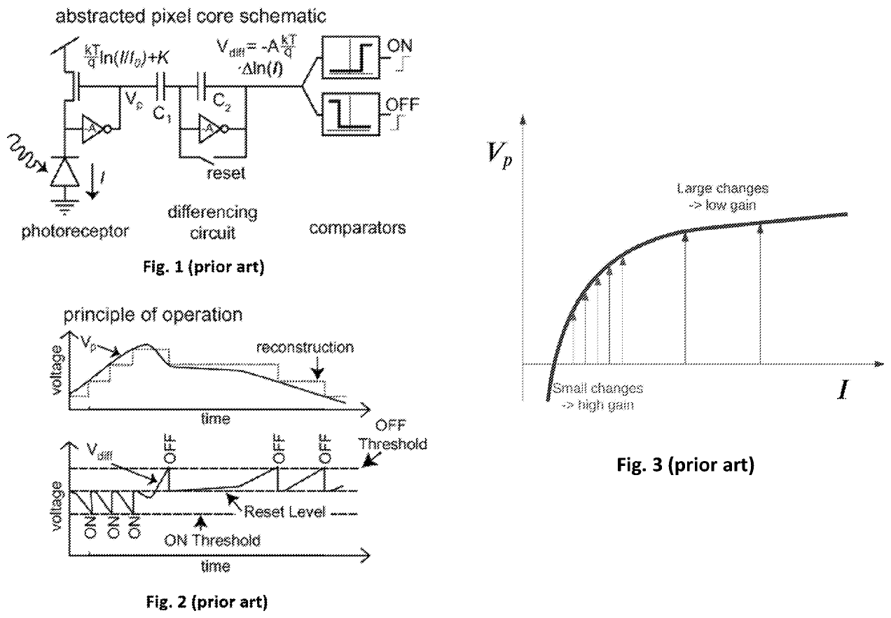

Some examples of kernels designed to detect edges are shown in FIG. 6. In FIG. 6-1, the kernels 301, 302 are configured to detect vertical and horizontal edges, respectively, so that their results can be combined to provide a gradient image. In FIG. 6-2, the kernels 303, 304 are also configured to detect vertical and horizontal edges, but with a weighting parameter “x” which can be tuned to values greater than 1 to emphasize the edges. The operators shown in FIG. 6 are examples only. It will be understood that other operators may be chosen as can be determined as appropriate by the skilled person, depending on the specific application. For instance, if it is known that the object(s) of interest have rotational symmetry, an operator or a mask may be chosen to emphasize edges about a centre.

The spatial filter 110 can be implemented as a software algorithm in some embodiments, but it can also be implemented in hardware in other embodiments. For hardware embodiments, the sliding frames approach may be simplified to a Fourier transform, which can significantly improve the hardware implementation. For example, this allows utilisation of hardware architectures for Fast Fourier Transform. The Fourier transform implementation looks for high frequency information in an image, given the transition from dark to light involves a sudden spike in intensity, which in the frequency domain is high frequency information. Thus the implementation will seek to remove the low frequency information via high-pass or band-pass filtering. Input signals are provided on a per-pixel basis to the Fourier transform hardware, which has the effect of applying a convolution (e.g., of the kernels shown in FIG. 6) to each pixel.

It should be noted that the size of the spatial filter is entirely programmable. This is particularly advantageous for the frame derived EBS which has a finite framerate. A very fast-moving object may traverse more than one pixel during a frame transition and thus, to track the edge, a large spatial filter can be employed to make sure the pixel transitions are correlated with changes in other pixels (which may or may not be adjacent).

The two-stage approach described above provides the benefit that the event-based sensing system is parameterizable. The conventional EBS is limited in its dynamic response, because it cannot change the physics of the diode (i.e., image sensor). In terms of dynamic range all it can do to add a compressive nonlinearity is to use the logarithm operation on the magnitude of the diode current. Similarly, the conventional EBS does not utilise memory, and rather, performs the change detection using a simple subtraction (e.g., equation 3).

The presently disclosed event-based sensing system, on the other hand, allows for flexibility in the choice of which type of compressive nonlinearity and parameters to implement, and can be configured by adjusting the frequency response and the number of taps as described above. This is because the processing applied in the first stage 102 is configurable rather than being restricted to taking a logarithm of the photodiode current. The system further utilises memory which as alluded to above, serves to reduce the effect of noise and thus, improves the ability to optimise the system for targets of various size and speed.

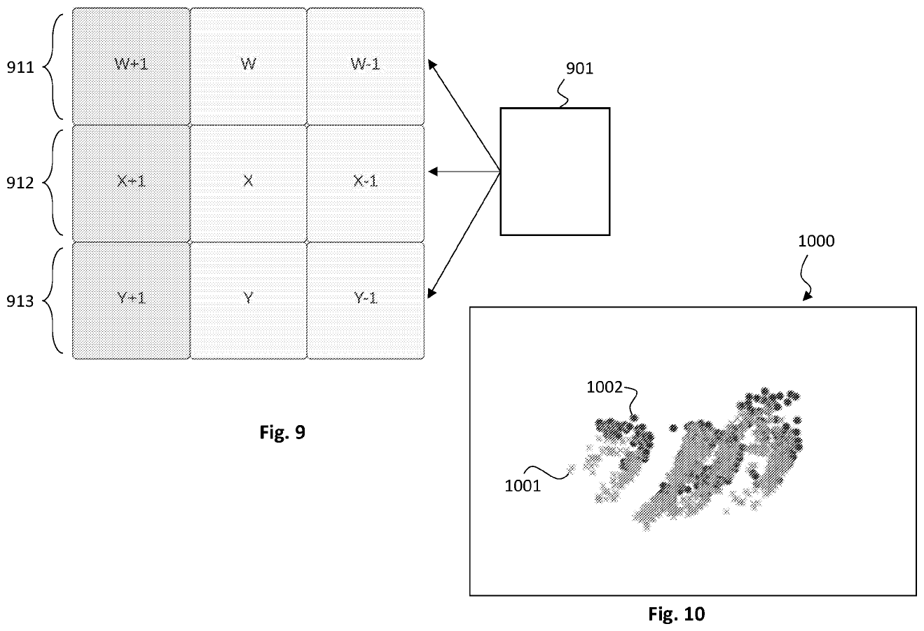

Furthermore, unlike the conventional EBS which generates an image by combining events, the present system allows nearly simultaneous frame-based pixel output and separate events output. The frame-based pixel output which is displayed can be the edge image or an enhancement thereof. Preferably the frame-based pixel output and the events output will be synchronised to the clocking cycle at the frame rate. Depending on the image sensor used, the user may see a full image of what is being recorded with latency less than 1 microsecond (us). The currently described system can leverage pipeline based processing in order to provide fast processing, as is described later with reference to FIG. 9.

It should be noted that the presently described system is agnostic to sensor technology. That is, it can be used with any sensor input including electro-optic, near-wave infrared (NIR), short-wave infrared, ultraviolet, and so on. This allows the system to provide the advantages offered by event-based processing using existing sensor technology, without specialised EBS technology. E.g. it is possible to use an infrared sensor to perform event based detection, without needing to develop an event-based infrared sensor.

FIGS. 7(a) and (b) schematically depict embodiments of the processing which occurs at the first stage 102 in the event-based sensing system 100. In a multi-pipeline approach, this processing may be done in one or more of the pipelines. This embodiment adds a compressive nonlinearity to the input pixels 106 which differs to that depicted in FIG. 3, in that the non-linear response changes depending on the lighting conditions.

Initially, the input signal 106 is processed by being passed through a low-pass filter 401 to remove low-frequency noise components. In this embodiment, the filtered signal is processed by multiple processing modules. The multiple processing modules include a processing module 402 which favours bright light or high contrast signals, and a processing module 403 which favours low light or low contrast signals. The processing module s 402, 403 each comprise a divisive low pass filter processing to reduce the effect of quantal noise in the signal arising from probabilistic noise in the image sensors. In the divisive low pass filtering, the low pass filter output is provided in a feedback loop to be divided by the input signal to the module (provided by the output from 401), and the divisive result is provided as an input to the low pass filter. In the processing module 402, the filter output (from filter 405) is further passed through a non-linear gain 404 which favours higher frequencies, prior to being divided by the processing module input (provided by filter 401). Following the low pass filter 405 with a non-linear gain 404 effects a band-pass behaviour for this processing module. In the example discussed in the below (e.g., equation 5), the non-linearity comprises an exponential gain.

The filter bands are selected to suit the frequency ranges being favoured by the respective modules 402, 403. The outputs from the processing modules 402, 403 are fed to a non-linear compression stage 409, so that the overall output signal for the first stage 102 is compressed to a particular range. That is, the non-linear compression stage 409 operates on data which have passed through the processing modules 402, 403. The specific processing architecture for data to be processed by the modules 402, 403 before being processed by the non-linear compression stage 409, can be selected by the skilled person depending on the application at hand.

For example, as the skilled person would understand, one possibility is parallel processing, where the modules 402, 403 process the output from the low-pass filter 401 in parallel, and then go into an operator 411, such as a summing or averaging operator, so that they can be fed to the non-linear compression stage 409 from the operator. This is shown in FIG. 7(a).

Of course, the skilled person will also understand, another way of combining processing is by processing the data through these modules 402, 403 in series, and then further in series to the non-linear compression stage 409, as shown in FIG. 7(b).

The non-linear compression stage 409 in this embodiment is implemented using Naka-Rushton/Gamma compression or something which approximates this compression. In other embodiments, other functions which asymptotically approach limiting values may be used as alternatives and can be chosen by the skilled person.

Examples of the filters applied are provided below. However it will be appreciated that modification may be made by the skilled person as appropriate to fit the scenario and application.

An example of the initial low-pass filtering path at filter 401 (see FIG. 7) is represented by Equation (4) below, defining a transfer function H₁ at different complex frequencies domain (z-domain referring to the complex frequency domain). In Equation (4), a sets the time constant. If α=0, then the output does not change i.e. the output is independent of the input, if α=1, then the output is equal to the input and the filter becomes a finite impulse response (FIR) filter. If α=−1, then the filter is unstable. Generally, we would choose a to be in the range: 0<α<1.

### Equation (4)

$${H}_{1} ( z ) = \frac{α}{1 - ( 1 - α ) {z}^{- 1}}$$

It should be noted that even the low-pass filtering here is expressed as a first order low pass filter, a higher order filter may be used. Using a higher order filter is expected to improve the image contrast in low light situations, but will require more memory. With currently available computing systems, the memory requirements tend to reduce the efficiency of the algorithm after the 3^{rd} order.

An example of the processing performed by the bright light processing path 402 is represented by Equation (5) below, defining a divisive low-pass transfer function H₂. Here β has the same function as a noted above, to set the filter time constant. The variable a determines the rate-of-change of the exponential. T scales the rate-of-change in the discrete-time domain (z-domain).

### Equation (5)

$${H}_{2} ( z ) = \frac{1 - ( 1 - β ) {z}^{- 1}}{β - β {e}^{a T} {z}^{- 1}}$$

The low light processing path applies a low pass filter 406. An example of the processing in path 403 is expressed as the transfer function defined by Equation (6) below, where y has the same function as a and B noted above.

### Equation (6)

$${H}_{3} ( z ) = \frac{1 - ( 1 - γ ) {z}^{- 1}}{γ}$$

The outputs from the processing paths 402, 403 are taken at the outputs of the division operators 407, 408, and then provided to a non-linear compression stage 409. An example of the non-linear compression 409 is implemented using a Naka-Rushton function which can be represented by Equation (7) below. Here R is the response to contrast C (which is the signal output of H2 and H3, where C=H2 in the high contrast path, and C=H3 in the low contrast path), K is the asymptotic maximum response amplitude, and n is proportional to the slope of the curve at the point where the contrast is taken to be K. b is a bias point around which the compression takes place. b is set by a direct current operating bias of the sensors.

### Equation (7)

$$R ( C ) = {R}_{max} \frac{1}{1 + \frac{{K}^{n}}{{C}^{n}}} + b$$

As alluded to above, the non-linear compression may be performed by other functions in different embodiments. For instance the Naka-Rushton function may be replaced by an inverse tan function. See Equation (8) below. Equation (8) is not a direct transformation of Equation (7) in that the parameters K, n, and b in Equation (7) and Equation (8) do not have the same values. However, like symbols in both equations are corresponding constants and have a similar effect on the response R. That is, K sets the maximum contrast, the slope is governed by n and b is an offset.

### Equation (8)

$$R ( C ) = {R}_{max} {tan}^{- 1} ( n C - K ) + b$$

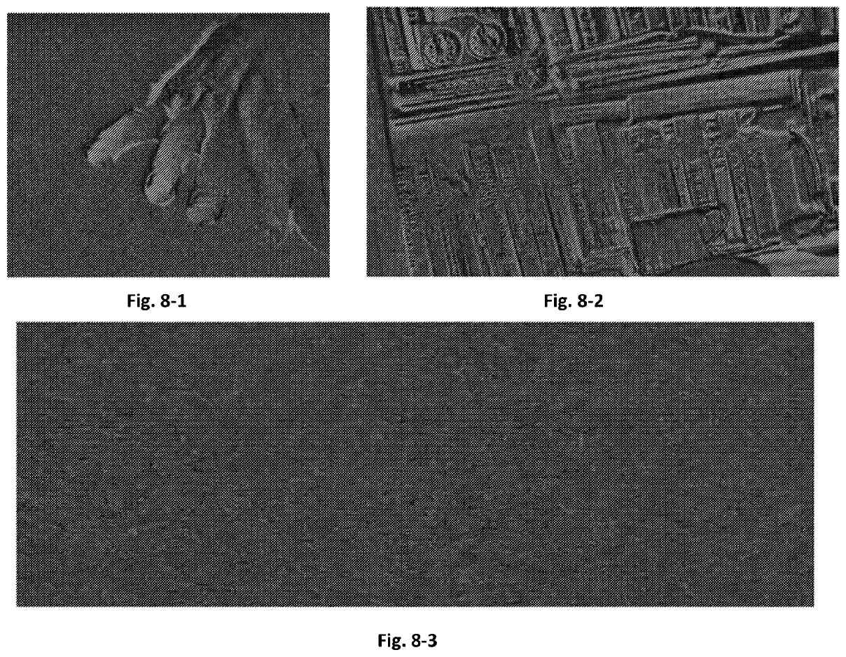

Examples of “pre-event” outputs, i.e., output of stage 2 prior to the events are generated, of an embodiment of the presently described system are shown in FIG. 8. FIG. 8-1 is the pre-event output image showing a moving hand. FIG. 8-2 is the pre-event output image showing a moving camera. FIG. 8-3 is the pre-event output image where no movements were captured in the original input image.

Variations and modifications may be made to the parts previously described without departing from the spirit or ambit of the disclosure.

For example, in the embodiments of the presently described system, the temporal high pass filter included in the second stage 104 may instead be a temporal IIR bandpass filter. This provides more targeted noise removal, or improves targeted noise removal, prior to the generation of the events. For example, the bandpass filter can be tuned to specifically filter moving objects of a known frequency or a known frequency range. For instance, bespoke EBS systems as well as the presently described system pick up the flashing of fluorescent lights. In the presently described system, a band-pass filter could be used to remove all movements at the known frequency or frequencies, thus reducing the effects of fluorescent lights on the image, without the need for a specific algorithm post-events to remove this noise. Another example would be to remove pixel changes in the frame due to ocean waves, when looking for objects out at sea. The wave movement is essentially noise and so a temporal band-pass filter could remove this noise before the generation of events. This selective removal of “noise” from known objects at particular frequency or frequencies reduces the amount of data that is generated via event generation, and thus improves the efficiency of system. It also means that specific algorithms which are commonly used to remove this noise after event-generation are not required, leading to a more efficient system. An example for the temporal bandpass filter is given in the equation below.

### Equation (9)

$$H ( z ) = K \frac{{( z + 1 )}^{N} {( z - 1 )}^{N}}{( z - {p}_{1} ) ( z - {p}_{2} ) … ( z - {p}_{2 N} )}$$

In Equation (9), K is a scaling factor, N is the number of zeros at 0 and infinity, and pₓ is the location of the filter poles.

As mentioned previously, in addition to implementing the spatial filter using an FFT, the spatial filter can be implemented using the pipeline structure. Here we maintain a memory of the previous pixels that were processed by the pipeline on the previous clock, and the pixels that are yet to be processed from the current frame. FIG. 9 illustrates an example. In this example, there are 3 parallel pipelines 911, 912, 913 to process a frame-based image output 901 which is a series of frames. In this example, the filtered value for pixel X is determined using 1) the pixel values at pixels W−1, X−1, and Y−1 which were processed by the pipelines 911, 912, 913 on the previous clock, 2) the pixel values at pixels W, X, Y which are processed by the pipelines 911, 912, 913 at the current clock, and 3) the pixel values at pixels W+1, X+1, and Y+1 from the current frame which are yet to be processed, as at the current clock cycle. Therefore, the pixel values at pixels W, X, Y, W−1, X−1, and Y−1 are values from the current frame but processed by the pipeline structure at the current and previous clock cycles, and the pixel values at pixels W+1, X+1, and Y+1 are values from the current frame. For example, the operation at pixel X for a spatial filter that is defined as:

$$[ \begin{matrix}- 1 & 0 & 1 \\ - 2 & 0 & 2 \\ - 1 & 0 & 1\end{matrix} ]$$

is then given by the equation pₓ=−(W+1)−2 (X+1)−(Y+1)+(W−1)+2 (X−1)+(Y−1). It will be understood that the form of pₓ is different for different spatial filters. Note that similar filters are required to find edges orthogonal to the x-axis.

In a more generalised example, the processing at the second stage 104 in some embodiments may omit the high-pass spatial filter all together. The result from stage 2 would thus be a frame-based pixel output showing movement. This still has the benefit of the ability to include configurable compressive non-linearity into the system, and the ability to use any off-the-shelf sensor to provide event-based detection.

Also, the embodiments may be implemented in hardware, such as analogue circuits which may be in the form of application-specific integrated circuits, or field-programmable gate arrays. Embodiments may utilise a digital signal processor (DSP) where the analogue input signal is transformed into digital signal and then processed by the DSP. In other embodiments, a mix of analogue and digital processing may be utilised, provided that the analogue to digital conversion occurs at the appropriate stage in the overall processing.

The event-based detection system disclosed herein is a novel implementation of an EBS. The method to manipulate images is parameterizable, which allows flexibility for the application of the event-based detection system, lighting conditions under which the system will work, and also flexibility in implementation. For example, depending on the feasibility of incorporating hardware, software implementation may be used in part or in full.

The event-based detection system described herein may have practical application in a range of scenarios. For example, in surveillance applications, event-based detection may be used to find a moving object in a complex scene. In defence systems, event-based detection may be used to track moving targets or monitored objects, such as unmanned aerial vehicles or missiles. Embodiments of the event-based detection system tuned to provide a “sub-pixel” level of event detection, in particular, will have the capability to detect an object when the object is far away from the sensor, such that the image (or data) for the object does not yet occupy a full pixel. This is unlike radar systems which are detectable, and aerial vehicles etc are less likely to be controlled to take evasive actions to avoid detection.

FIG. 10 shows a rendered image of an event output, processed from image input showing a flying drone. The processing algorithm used for this example included first order temporal filters, but no spatial filtering in the second stage of processing. The crosses represent the “OFF” events (where the drone had been but no longer detected there), whereas the circles represent the “ON” events (where the drone is now detected). It can be seen here that the clusters of “ON” event circles indicate leading edges moving towards the upper right-hand side of the image. The clusters of “OFF” event crosses indicate where the drone had been.

Another area where event-based detection is potentially useful is space applications. For instance this can be used to detect and track space junk or satellites. In particular, embodiments in which the input is provided by infrared image sensors may be useful in detecting “events” to provide space situational awareness, e.g., by tracking heat signatures of orbiting objects such as satellites.

A further area where event-based detection may be useful is in autonomous vehicle applications. For example, it may be used in the detection of moving objects in the path of the autonomous vehicle, to provide situational awareness. Another example is lane-tracking, to track whether there has been a relative movement between the positioning of the lane in relation to that of the vehicle. This can help to detect when the vehicle has deviated or started to deviate from the lane. A further example is stabilisation control. The events output can be used to algorithmically determine the motion of the camera and use this to remove the self-motion from the output. This removes the need for a gimbal.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An image processing method comprising:
obtaining a time series of input signal data characterizing information from an input source;
applying a first stage of processing, wherein the first stage of processing comprises applying a compressive non-linearity to the input signal data; and
applying a second stage of processing to an output from the first stage of processing, wherein the second stage of processing comprises spatial and/or temporal processing in a feedback loop, to apply a high- or band-pass spatial and/or temporal filter to the output from the first stage of processing, to thereby suppress recurring changes, and improving an event to recurring change ratio in the output from the first stage of processing.

2. The method of claim 1, comprising detecting events in an output of the second stage of processing.

3. The method of claim 2, wherein said detecting events comprises applying at least one threshold to pixel values in the output of the second stage of processing.

4. (canceled)

5. The method of claim 2, including setting an event speed for a detected event.

6. The method of claim 5, including setting two different event speeds, each for a respective one of two different detected events.

7. (canceled)

8. The method of claim 1, wherein the temporal high-pass or band-pass filter is an nth order filter, wherein n corresponds to a number of time steps incorporated in the temporal processing.

9. (canceled)

10. (canceled)

11. The method of claim 1, wherein the temporal high-pass or band-pass filter is an infinite impulse response filter.

12. The method of claim 1, wherein the frequency cutoff for the temporal high- or band-pass filter is variable based on at least one or more of: a characteristic of the input source; a characteristic of an environment about which the input source is acquiring the input data.

13. The method of claim 1, wherein the second stage of processing further comprises a spatial processing configured to detect edges.

14. (canceled)

15. The method of claim 13, wherein the spatial processing applies a high-pass filter implemented using convolution.

16. The method of claim 1, wherein the first stage of processing comprises a temporal feedback loop, in which current and previous samples from the input signal data and at least a previous sample of the output from the first stage of processing are used to obtain a current sample of the output from the first stage of processing.

17. The method of claim 1, wherein applying said compressive non-linearity to the input data comprises applying a gain to the input signal data, the gain being variable on the basis of a magnitude of the input signal data.

18. The method of claim 1, wherein the first stage of processing comprises a plurality of processing modules, each configured for favourably processing input data of a different characteristic.

19. The method of claim 18, wherein the processing paths comprises a first processing module for favourably processing input data of lower magnitudes or lower contrasts, and a second processing module for favourably processing input data of higher magnitudes or higher contrasts.

20. (canceled)

21. The method of claim 1, wherein the input source comprises an image sensor, and the times series of input data is a series of frames, each frame comprising a plurality of pixels, where the first and second stages of processing are applied on a per-pixel basis.

22. (canceled)

23. A signal processing device comprising a plurality of processing modules, the modules comprising
a first processing module configured to receive and process a time series of input signal from an input source, wherein the first processing module is configured to apply a compressive non-linearity to the received input signal; and
a second processing module configured to receive output from the first processing module, wherein the second processing module is configured to implement spatial and/or temporal processing in a feedback loop, to apply a high- or band-pass spatial and/or temporal filter to the output from the first stage of processing, to thereby suppress recurring changes, and improving an event to recurring change ratio in the output from the first stage of processing.

24. The device of claim 23, further comprising an event detection module configured to implement event detection to an output from the second processing module.

25. The device of claim 23, wherein the second processing module is further configured to apply a spatial filtering process to detect edges in the output of the first processing module.

26. The device of claim 24, wherein the first processing module or the second processing module, or both, is implemented in hardware.

27. The device of claim 24, wherein input signal comprises signal data for a set of pixels, wherein the processing modules process the input signal pixel by pixel.
